(19) United States
(12) Patent Application Publication
(10) Pub. No.: US 2011/0122329 A1
(43) Pub. Date: May 26, 2011

(54) DISPLAY

(75) Inventors: Benjamin John Broughton, Oxford (GB); Allan Evans, Oxford (GB); Michel Sagardoyburu, Oxford (GB); Nathan James Smith, Oxford (GB); Lesley Anne Parry-Jones, Oxford (GB); Diana Ulrich Kean, Oxford (GB)

(73) Assignee: SHARP KABUSHIKI KAISHA, Osaka-shi, Osaka (JP)

(21) Appl. No.: 12/867,555

(22) PCT Filed: Feb. 20, 2009
(86) PCT No.: PCT/JP2009/053618

§ 371 Date: Aug. 13, 2010

(30) Foreign Application Priority Data
Feb. 21, 2008 (GB) 0803172.6

(51) Int. Cl. G02F 1/1335; G02F 1/29; G02B 27/22; G02F 1/01

(52) U.S. Cl. 349/15; 359/316; 359/245

(57) ABSTRACT

A display for providing several viewing modes of different angular viewing characteristics comprises a display device and a passive optical device (9) of a parallax optic of fixed optical characteristics. The display device comprises a light emitting or modulating layer (7) between first and second electrode arrangements (5, 10, 11). The first electrode arrangement (5) comprises a plurality of pixel electrodes defining pixels of the display device. The second electrode arrangement comprises a plurality of counter electrodes (10, 11) arranged so that each of the pixel electrodes (5) faces a portion of each of the counter electrodes. The counter electrodes are controllable so as to select which portion of each pixel is active. This provides, in cooperation with the optical device (9) the plurality of display viewing modes.

### TECHNICAL FIELD

The present invention relates to a display. Such a display may comprise an active matrix display device and may be electrically switchable between two or more modes of operation. In a first such mode, the display may behave as a standard display, showing two-dimensional image information and generally having as wide a viewing angle range as possible with maximum brightness and resolution for all viewers. In additional such modes, the display may have some form of added functionality, such as three dimensional (3D) image capability, a private viewing mode, or a dual view mode in which two different images are displayed to different viewing angle ranges from the one display.

Such displays may be applied to many apparatuses where a user may benefit from the increased capability of a multi-function display, or the optimum optical characteristics of the display may change depending on the situation in which the display is being used. Examples of such apparatuses include mobile phones, Personal Digital Assistants (PDAs), laptop computers, desktop monitors, Automatic Teller Machines (ATMs) and Electronic Point of Sale (EPOS) equipment. Such apparatuses may also be beneficial in situations where it is distracting and therefore unsafe for certain viewers (for example drivers or those operating heavy machinery) to be able to see certain images at certain times, for example an in car television screen while the car is in motion.

### BACKGROUND ART

Electronic display devices, such as monitors used with computers and screens built into telephones and portable information devices, have been produced which have a switchable optical functionality. Such devices include the Sharp Actius RD3D laptop computer, which has a liquid crystal device (LCD) display which is switchable between a normal two-dimensional viewing mode and an autostereoscopic three-dimensional viewing mode in which the appearance of depth is generated for objects displayed on the screen. Another example is the Sharp Sh902i mobile phone device, which has an LCD display which is switchable between a public mode, in which information displayed on the device is viewable from a wide range of angles, and a private mode in which the information displayed by the device is only intelligible from within a reduced range of viewing angles centred on the normal to the display screen.

In the multi-function display device products mentioned above, the switch from the standard two-dimensional (2D) display mode to the added functional mode requires either changing the physical state of some active optical arrangement which is present in addition to the standard display device (as would be required solely to display a standard 2D image only), or switching the image data displayed by the device, or both.

A multi-function display device which can switch between viewing modes simply by changing the image data supplied to the display, perhaps in collaboration with some passive optical arrangement, can be considered advantageous as: no expensive extra switching hardware is required; the display draws no extra power operating in the added functionality mode relative to the standard 2D mode; and the cost of modifying the hardware of existing production displays to incorporate the added functionality is minimised. Examples of such devices are the known 3D display type based on an LCD display and additional lenticular optical arrangement, an example of which is disclosed in EP 0625861 (Sharp, 1993), and the dual view display type based on an LCD and additional parallax barrier optical arrangement disclosed in US20050111100A1(Sharp, 2003) and US20050200781A1 (Sharp, 2004).

In such a display, a multiview display mode is achieved by grouping columns of pixels together under a single lens or barrier element and displaying multiple interlaced images on the column groups such that the multiple images are separated to different viewing regions. In such displays, a 2D mode can be achieved by displaying the same image data on all the pixel columns in a group. However, both of these display modes result in a loss of effective display resolution, as each eye or each viewer sees only a portion of the TFT switched pixels comprising the underlying display. As a result, multiview displays which have some active optical arrangement allowing all pixels to be visible to all viewing regions in the 2D mode, thereby preserving resolution, have been developed. Examples of these include the 3D displays disclosed in U.S. Pat. No. 6,046,849 (Sharp, 1996) and WO03015424A2 (Ocuity, 2001). However, these display types still suffer from the unavoidable resolution loss resulting from interlacing multiple images on a single display and separating them to different viewing regions while in the added function mode, and the added expense of the additional active optical arrangement.

One example of a display device with privacy mode capability and no resolution loss in either mode is the Sharp Sh702iS mobile phone. This uses a manipulation of the image data displayed on the phone's LCD, in conjunction with the angular data-luminance properties inherent to the liquid crystal mode used in the display, to produce a private mode in which the displayed information is unintelligible to viewers observing the display from an off-centre position. However, the quality of the image displayed to the legitimate, on-axis viewer in the private mode is severely degraded.

U.S. Pat. No. 4,973,135 (Canon, 1984) describes the structure of an active matrix LCD display with multiple, striped counter electrodes. This comprises a plurality of signal and gate lines defining a matrix array, a TFT switch at each intersection of the gate and signal lines, and an electrode region connected to the output (drain) of each TFT on one substrate. On the opposing counter substrate is arranged a plurality of striped counter electrode regions arranged in groups, each group aligning counter to each column of TFT controlled electrode regions on the active matrix substrate to define a set of display pixel regions controlled by a combination of active matrix and passive matrix addressing. In such a way, the effective resolution of an active matrix display can be increased without increasing the number of TFT's required. A problem arises with this scheme, however, as the response of nematic liquid crystals to an applied electric field is independent of the field polarity, so individual selection of one of the pixel regions within a single TFT controlled area for receipt of a data voltage cannot be achieved with voltages applied to the multiple counter electrodes globally over the whole display, irrespective of the data voltages. For this reason, the scheme is applicable particularly to ferroelectric liquid crystal devices which are bistable and field polarity switched. A method for applying a compensation signal, dependent on the data signal, to the counter electrodes, and therefore making the scheme applicable to resolution enhancement of nematic LCDs is given in the Journal of the SID, 4/1 1996, pp 9-17.

A fringe-field switching (FFS) type LCD display with a counter electrode disposed on the substrate opposing the active matrix substrate is disclosed in US20060267905A1 (Casio, 2005). In this scheme, the voltage applied to the counter electrode is used to reorient the LC director out of the plane of the cell to some extent, and therefore produce an angular light transmission profile which is asymmetric and therefore to some degree private. However, the counter electrode described is uniform across the whole display and therefore cannot be used to switch off portions of the display pixels only, as this would result in a black image to all viewers. There is also no mention of using the counter electrode switch in conjunction with some passive optical arrangement to alter the directionality of light output form the display.

A similar hybrid addressing scheme for application to LED and OLED displays is given in U.S. Pat. No. 6,421,033 (ITL, 2000). Due to the diode nature of the light emitting mechanism of OLED displays, the aforementioned problems for LCDs are not applicable and a similar active matrix and plural counter electrode (cathode) arrangement can be used in OLED displays to increase the number of effective pixels per TFT addressed region in the display. However, such a combined active-passive matrix addressing scheme requires the multiple pixels within each TFT addressed region to be addressed time-sequentially within an image frame-time, which results in an overall loss of brightness in comparison to a fully active-matrix addressed OLED display, in which all pixels can be “on” for the whole duration of the frame. Also, U.S. Pat. No. 6,421,033 does not propose to use the multiple counter electrodes to control any aspect of the display optical function, only to provide effective resolution enhancement to an active matrix display without increasing the total number of TFTs.

Other devices which incorporate multiple cathode electrodes opposing the active matrix substrate in OLED type displays have also been proposed in:

US 2006 027981 A1 (Au Optronics, 2004), in which two counter electrodes are disposed on alternate top and bottom emitting OLED pixels to produce a double sided display;

US 26012708 A1 (Philips, 2002), in which separate counter electrodes are utilised for each of the red, green and blue pixel groups in order to individually control the duty cycle for the respective coloured light emissive materials and so mitigate their differential aging problems; and

US 2006 038752 A1 (Eastman Kodak, 2004), in which display pixels are grouped into pairs which are provided with a shared power line, in order to reduce the total number of metallic lines required by the active matrix array and thereby increase the total area of light emitting regions relative to the total area of the display. A double cathode arrangement is used so that the pixels in each pair can have opposite diode polarity, thereby minimising the current load on the shared power line by requiring it to supply only the difference in current through the pixels in the pair, rather than the sum.

It can therefore be seen that, while some of the above documents describe a multiple counter electrode arrangement in electroluminescent display devices in order to select which region of a TFT addressed pixel area emits light at a given time, in none of the prior art is this used to switch the optical functionality of the display and nowhere is it suggested that switching between causing all of the TFT switched pixel area to emit light and causing only a portion of that area to emit light can change the viewing characteristics of the display.

It is therefore desirable to provide a multi-function display in which some or all of every TFT switched pixel region of the active matrix display is visible to viewers in at least one location in all of the display modes, the switching between display modes being achieved by controlling the voltage on a plurality of counter electrodes, allowing control of the optical properties over the whole of the display area without manipulation of the image data supplied to the active matrix array.

### DISCLOSURE OF INVENTION

According to the invention, there is provided a display comprising a display device and a passive optical device, the display device comprising a light emitting or modulating layer disposed between first and second electrode arrangements, the first electrode arrangement comprising a plurality of pixel electrodes defining pixels of the display device, the second electrode arrangement comprising a plurality of counter electrodes arranged such that each of the pixel electrodes faces a portion of each of the counter electrodes, which are controllable so as to select which portion of each pixel is active to provide, in cooperation with the optical device, a plurality of display viewing modes having different angular viewing characteristics.

It is thus possible to provide switching between display modes in a multi-function active-matrix display device without the need for a hardware switch in an active optical arrangement present in addition to the display panel, and without the need for manipulation of the image data input to the active matrix array. The switch is performed by altering the electronic signals provided to a plurality of counter electrodes, each of which is arranged to oppose a portion of each of the independently addressed pixels of the active matrix array. In this manner, the signal applied to the counter electrode arrangement determines the region of the independently controlled active matrix pixel from which light is emitted. This, in conjunction with some passive optical arrangement, controls the macroscopic viewing properties, e.g. the light directionality, of the display.

### BRIEF DESCRIPTION OF DRAWINGS

FIG. 1 is an exploded schematic diagram illustrating the principal components of an embodiment of a display having a mode switching mechanism;

FIG. 2 is a cross-sectional schematic of the embodiment shown in FIG. 1, illustrating the method whereby the plurality of cathodes control the directionality of light emitted by the display;

FIG. 3 is a circuit diagram showing an example control circuit for each pixel of the device;

FIG. 4 is an exploded schematic diagram illustrating the principal components of a further embodiment with the mode switching mechanism providing a low-power, light directing display;

FIG. 5 illustrates the use of the embodiment shown in FIG. 4 in a head-tracking display;

FIG. 6 is a cross-sectional schematic of a further embodiment providing a switchable autostereoscopic 3D to dual view display mode, shown in the 3D mode;

FIG. 7 is a cross-sectional schematic of a further embodiment providing a switchable autostereoscopic 3D to dual view display mode, shown in the dual view mode;

FIG. 8 is a schematic of a still further embodiment which provides a switchable dual-view display;

FIG. 9 is a diagram of a display providing two dimensional control of directionality;

FIG. 10 is a diagram of a display providing improved uniformity of brightness;

FIG. 11 is a diagram of a display providing dual-sided operation;

FIG. 12 is a diagram of a liquid crystal based display illustrating a public viewing mode; and

FIG. 13 is a diagram illustrating the display of FIG. 12 in a private viewing mode.

### BEST MODE FOR CARRYING OUT THE INVENTION

In a preferred embodiment, the display panel is an active matrix OLED display comprising a substrate, 1, usually glass, onto which is patterned an array of independently addressable picture elements or “pixels”. The pixels comprise an electronic switching arrangement, 2, which receives image and timing data from one each of the plurality of gate, 3, and data, 4, lines comprising the array as is standard in active matrix displays, and which outputs electric current to an anode electrode region, 5. In OLED displays, it is also standard for each pixel to be supplied with electric current from one of a plurality of power lines, 6, also comprising the matrix array. The pixels also comprise a light emitting layer in the form of an electroluminescent layer, 7, substantially covering the anode electrode region, which emits light with intensity dependent on the current supplied to it by the electronic switching arrangement. This electroluminescent layer may comprise a plurality of layers of different organic materials, such as but not limited to a hole injection layer, a hole transport layer, emission layers and electron transport layer, as is also standard. (SID'07 Digest, pp 1691-1694).

In contrast to a standard OLED display in which all pixels share a common cathode electrode which extends over the entire display area, the device of this embodiment possesses a plurality of cathode electrode regions, 8, each of which is arranged to cover a portion of each of the anode regions of the display pixels. As the brightness of any pixel is determined by the magnitude of the electric current flowing through the organic layers, from the anode to the cathode, the portion of each pixel from which light emission occurs is determined by the overlap area between the pixel anode and whichever of the cathodes are at a suitable voltage to receive the current. In this manner, the region of each pixel from which light emission occurs can be controlled by controlling the voltages on the plurality of cathode electrodes.

Generally in OLED displays, either the anode or cathode electrode region will be formed of a transparent conducting material such as indium-tin oxide and the other will comprise of a reflective metallic conductor, depending on whether it is desirable for substantially all of the light emitted by the pixel to exit the display away from or through the glass substrate.

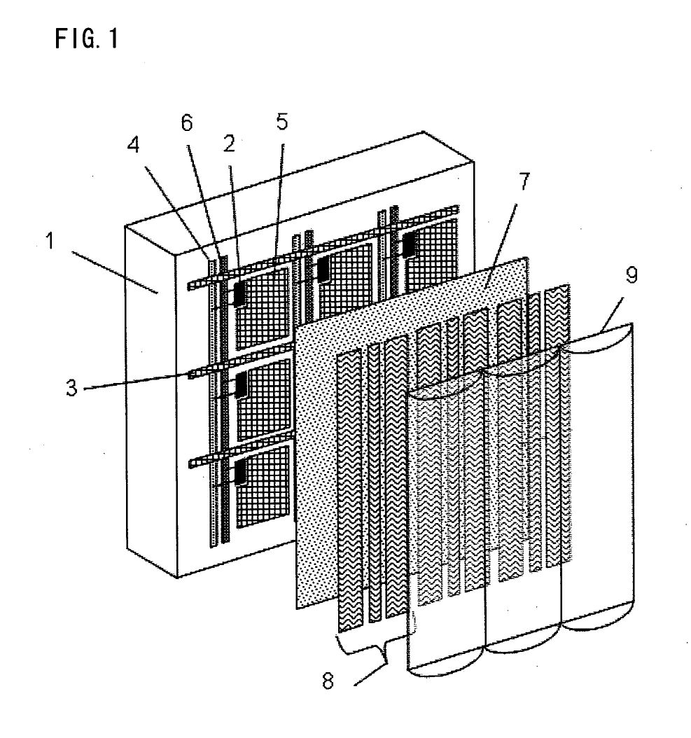

In this embodiment, a passive optical device, 9, in the form of a parallax optic comprising a one dimensional array of parallax elements, such as a lenticular array or parallax barrier or combined lenticular and parallax barrier arrangement, is then utilised such that the electrical switching of the region of the pixels from which light is emitted results in an alteration of the viewing region into which the light from the pixel is directed. Each pixel is aligned with a parallax element. In FIG. 1, each parallax element comprises a cylindrically converging lens aligned with a column of pixels.

An exploded schematic diagram of the components of this embodiment as described is given in FIG. 1.

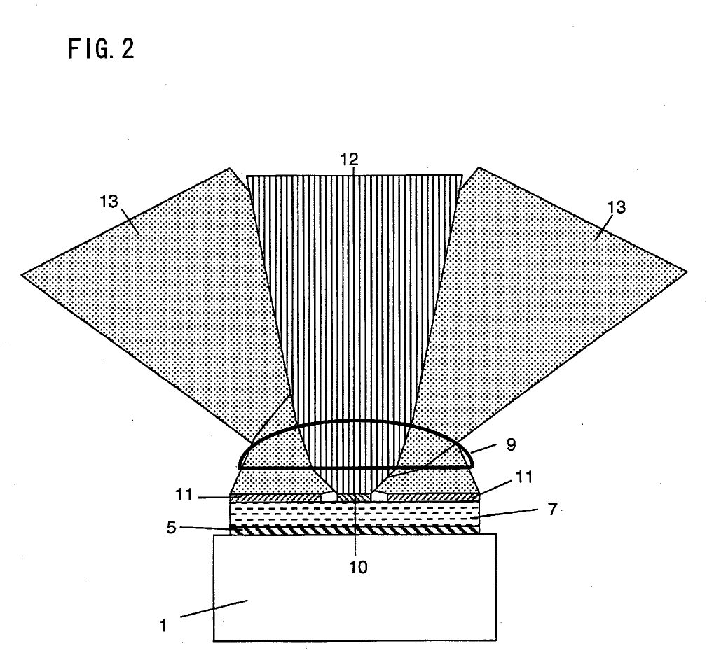

FIG. 2 is a cross-sectional schematic diagram of such a device, illustrating the manner in which switching the various cathode regions, 10, 11, can switch the light emitted by the pixel between being directed into an on-axis viewing window, 12, which would provide private mode operation, and side viewing regions, 13, which in combination with the on-axis viewing region, 12, would provide a wide-view public mode. It should be noted that this diagram is for illustrative purposes only, and is not to scale. The separation between each optical element of the passive optical device, 9, and the light, emitting regions, as well as the optical characteristics of the optical element, e.g. focal length of the lens, and the geometry of the light emitting regions themselves will determine the angular extent of the viewing regions and these will be specified according to the device application.

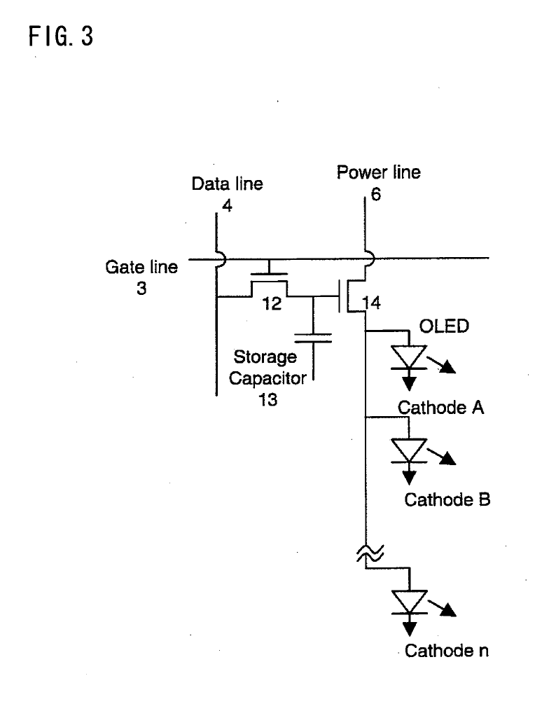

An example of a possible circuit diagram of the electronic switching arrangement, 2, is given in FIG. 3. In such an arrangement, the pixel is activated by a timing signal applied to the gate line, 3, the standard approach being to activate all rows of pixels of the display sequentially within an image frame. The gate signal is applied to the gate terminal of transistor 12, allowing the storage capacitor, 13, to charge to the image data voltage supplied by the data line, 4. The gate terminal of the second transistor, 14, is then held at this data voltage for the duration of the frame time, after the gate signal on transistor 12 is removed. The transistor 14 is operated in the linear regime such that the values of the data voltage applied to the gate terminal determine the effective resistance of the transistor, 14, for current flowing from the power line, 6, to the anode electrode, 5. In this manner, if a constant positive voltage is maintained between the power line and the pixel cathode, the diode structure of the electroluminescent layer is in a forward biased condition and the data voltage applied to the data line, 4, controls the current through the electroluminescent layer, 7 and therefore the luminance of the pixel. This much is standard in OLED display driving schemes.

In this embodiment, there are then a number of cathode regions corresponding to different areas of the pixel. If these cathodes are all held at some voltage lower than the voltage of the power line, e.g. ground, then current will flow to all cathodes and substantially the whole pixel will emit light. If however the voltage on one or more of the cathodes is raised to substantially match that on the power line, then no current will flow to those cathodes irrespective of the data voltage and the regions of the pixel to which they correspond will emit no light, altering the angular range into which the light is directed. As each of the cathodes covers a portion of each of the pixels in the entire display, the viewing angle properties of the display can be switched globally by controlling a few cathode voltages, irrespective of the image data.

If a first cathode 10, covers an area of each pixel substantially central to the pixel area and the lens of the optical element and a second cathode, 11, covers the remaining, side regions of the pixel, as depicted in FIG. 2, then only two cathode regions are required, and a display is provided which is globally switchable between public and private viewing modes simply by changing the voltage applied to one of two cathode electrodes.

It should be noted that, although the electroluminescent layer, 7, is shown as being continuous over the area of the TFT switched electrode region, 5, in FIGS. 1 and 2, this does not have to be the case. The presence of gaps in the electroluminescent layer between the separate cathode regions, 8, may help prevent current flowing between cathodes when they are held at different voltages, via the electroluminescent layer, which may be advantageous. The addition of diode elements to the connections to the cathode electrodes, 8, may also be used to ensure current can only flow from the electroluminescent layer to the cathodes, and not from cathode to cathode which may be undesirable.

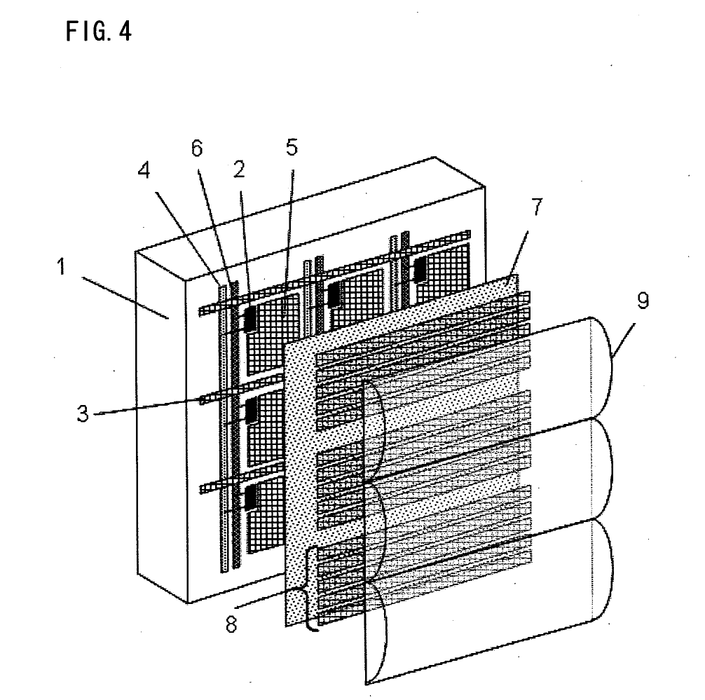

In a further embodiment, the number of cathode regions per pixel is increased beyond two to provide finer control of the directionality of the light emitted by the display pixels. In this manner, the display can be used in conjunction with some user tracking apparatus in order to steer the light emitted by the display towards a mobile viewer. This allows a power saving over a conventional display as the amount of light emitted by the display and directed into viewing regions in which there are no viewers is reduced. FIG. 4 illustrates an example of a display for controlling the vertical angular range.

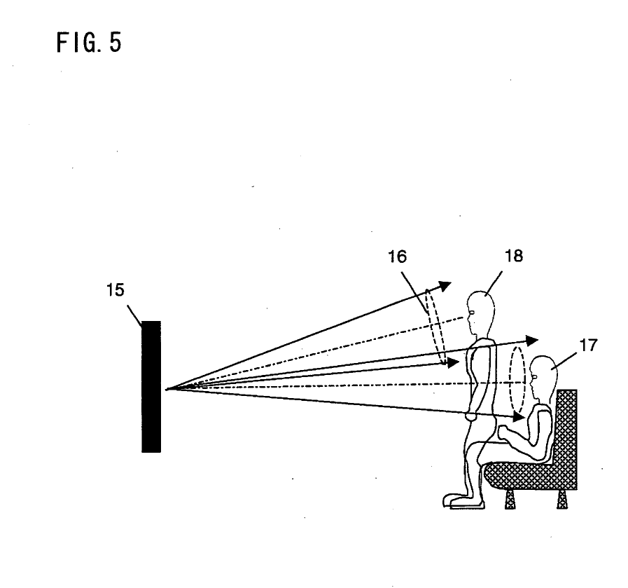

FIG. 5 shows a possible application for a display, 15, of the type shown in FIG. 4. The horizontally striped cathodes, 8, and horizontally arranged lenticular array allow control over the vertical angular range into which an image is displayed. The lenticular array 9 concentrates the light output by the display 15 into a cone, 16, centred on a viewer's head, saving power. A user tracking device incorporated into the display 15 detects the viewer's position and outputs a signal allowing the cathode voltages to be adjusted to redirect the image cone vertically according to the viewer's current height, i.e. sitting, 17 or standing, 18. This type of system can also accommodate multiple viewers by displaying the image to multiple angular regions sequentially within a frame.

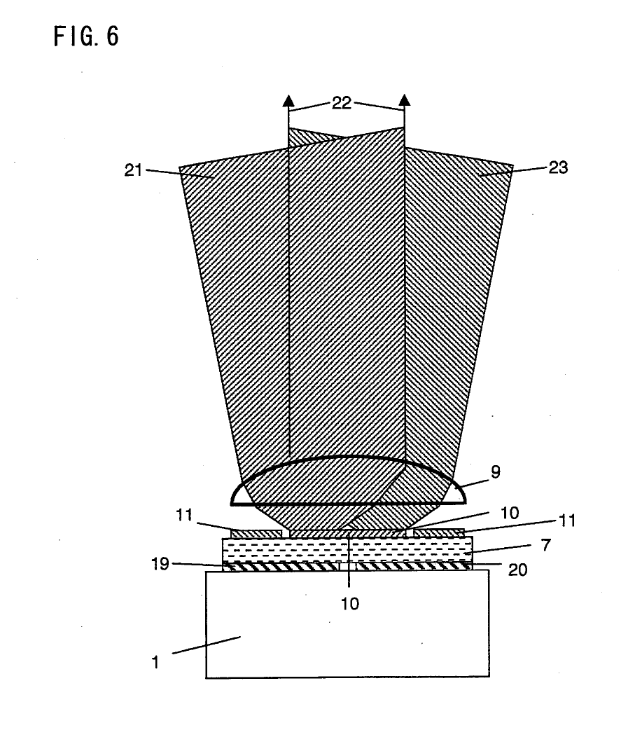

In a still further embodiment, the striped cathodes are arranged so as to provide switching between an autostereoscopic 3D display mode and a dual view display mode. In this embodiment, first and second independently controlled pixel regions, with associated anode electrodes, 19, 20, are positioned under each segment of the lens array. In the 3D mode, voltages supplied to the first 10 and second 11 cathodes are such that light emission occurs from the region corresponding to the first cathode 10 but not the second 11. The relative position of the cathode electrodes and the optical element results in the light from the first pixel being directed into a first viewing cone 21, centred left of the display normal, with an edge substantially parallel to the display normal 22, while the light from the second pixel is directed into a second viewing cone 23, centred on the right of the display normal, again with one edge substantially parallel to the display normal 22. Such an arrangement is shown in FIG. 6.

This arrangement provides a means whereby two images constituting a stereoscopic pair can be displayed in an interlaced manner on alternate display pixels and thereby directed to the separate eyes of a viewer positioned substantially along the display normal. In this case, a 3D image with depth will be perceived by the viewer.

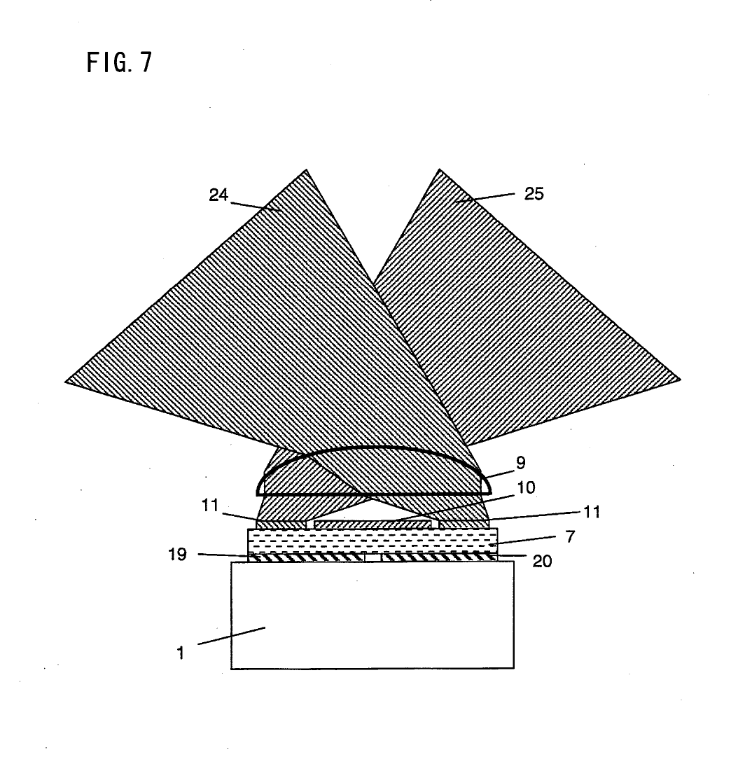

In order to switch from the 3D to a dual view mode, the voltages on the cathodes are exchanged, such that each of the two pixel regions now emits light corresponding to the second cathode 11, but not the first, 10. The relative position of the cathode electrodes and the optical element now results in the light from the first pixel being directed into a first viewing cone 24, centred left of the display normal, while the light from the second pixel is directed into a second viewing cone 25, centred on the right of the display normal. The angular separation of the two views is now such that two images displayed in an interlaced fashion on the display can be separated to two different viewers on opposite sides of the display, thereby providing a dual view display. This situation is illustrated in FIG. 7.

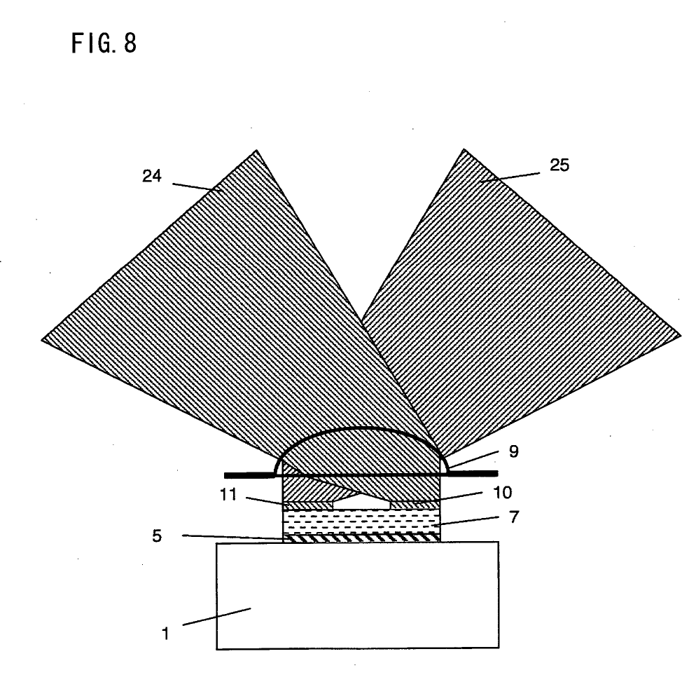

In a still further embodiment, a full resolution dual view display is provided. A single anode region 5 is positioned under each element of the passive optical device, 9, which may be a combined lenticular and barrier arrangement as depicted in FIG. 8 with a respective lens being disposed in each aperture of the barrier. The two cathode regions 10 and are then positioned such that light emitted from the region of the electroluminescent layer 7 corresponding to the first cathode region 10 is directed into a first viewing window 24 to one side of the display normal and light emitted from the region corresponding to the second cathode region 11 is directed into a second viewing window 25 to the opposite side of the display normal. The voltages on each cathode region are such that light is emitted from both cathode regions sequentially within a frame period and the image data voltage is altered for each corresponding portion of the frame period, such that two different images are displayed time-sequentially to the two different viewing regions providing a dual view display in which each viewer sees a portion of every TFT controlled pixel element and display resolution is therefore maintained. The embodiment can also then be switched to a standard 2D mode in which a single image is displayed to both viewing regions simultaneously for the whole frame time by switching the cathode voltages such that both regions emit light.

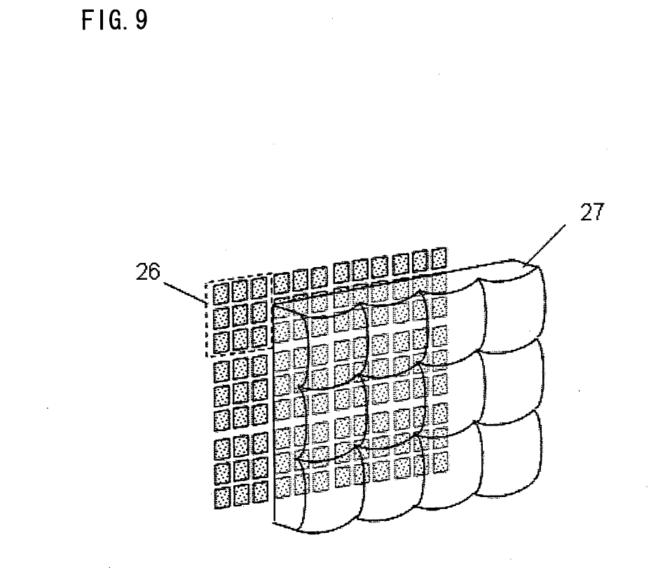

In the embodiments described previously, the corresponding drawings depict only horizontal and vertical stripe shaped cathode regions and optical features, however the embodiments are not limited to this geometry. Horizontally and vertically defined cathode regions 26 may be utilised in conjunction with a passive optical device in the form of a two dimensional lenticular array 27 in order to allow both vertical and horizontal control of the direction of light emitted by the pixels, as illustrated in FIG. 9. The array 27 forms a two dimensional array of parallax elements.

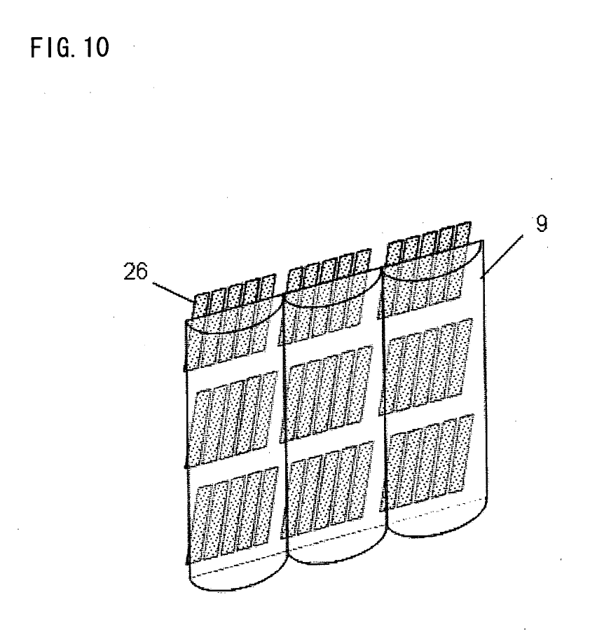

Also, the uniformity of pixel brightness between viewing cones corresponding to light emitted via neighbouring cathode regions can be improved by angling the cathode stripes with respect to the lenticular array. This is illustrated in FIG. 10.

It can be seen that myriad cathode region geometries and optical arrangements can be employed in multi-mode display devices to produce switching between a variety of optical characteristics without departing from the underlying switching mechanism described herein.

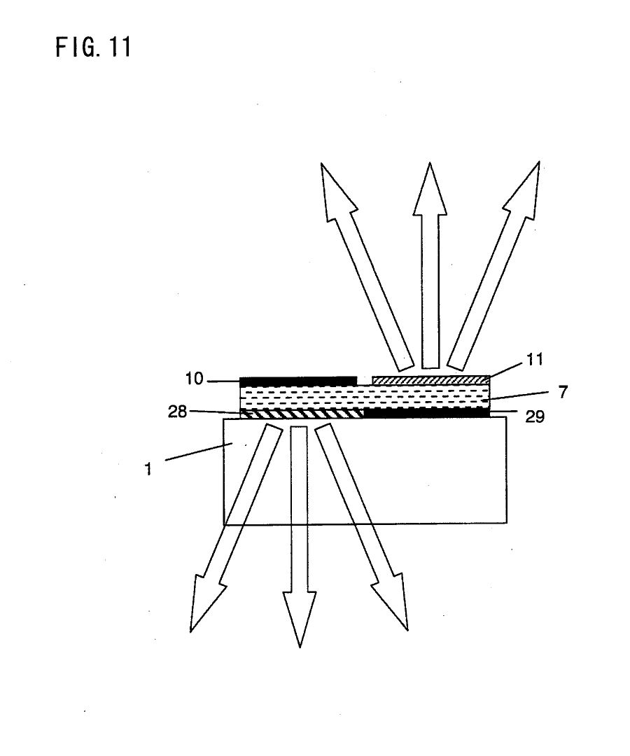

In a still further embodiment, a first part of the pixel anode region, 28, is formed from a layer of transparent electrically conducting material such as ITO and a second part of the pixel anode region, 29, is fabricated from a reflective conducting material, such as a metal layer. The first cathode 10 is then a reflective conductor and is arranged to substantially oppose the first anode region 28 whereas the second cathode 11 is a transparent conductor and is arranged to substantially oppose the second anode region 29. The first cathode 10 and the second part of the anode region 29 form a patterned mirror. In this manner, the light emitted by each pixel of the display is directed both away from and through the glass substrate, as illustrated in FIG. 11, similar to the device described in US 2006 027981 A1.

In this embodiment, the top and bottom emitting regions do not have independent control of the light emission, as a single electrical control arrangement 2 is used by both regions, so the same image will be observed from both sides of the display. However, this embodiment has the advantage that, by altering the voltage of the cathodes in the manner described in the previous embodiments such that light is emitted from the region corresponding to one cathode only, the side of the display from which light is emitted can be controlled, thereby saving power when the display is only being viewed from a single side and reducing the number of TFT switching elements relative to the prior art. One application for which such a device would be advantageous would be a clam-shell mobile phone in which the side of the display on which an image is displayed could be automatically switched according to whether the phone is in the open or closed position.

The embodiment as described is also capable of displaying different images on the opposite sides of the display by switching the voltages applied to the cathodes within a frame period and synchronising a change in the image data with this switch. In this way, a first image is displayed on one side of the display for half of each frame period and a second image is displayed on the other side of the display for the other half of the frame period. This results in a loss of brightness for each image in comparison to a simultaneous double sided display, due to the shared duty cycle, but the required number of independent switching elements required is also reduced by half.

In a still further embodiment, the display panel is an

LED rather than an OLED type. In this embodiment, the device construction and electronic operation are essentially as illustrated in FIGS. 1 and 3; only the light emitting diode materials used are standard semiconductor materials rather than organic equivalents.

It is also the case that the capability provided by the above embodiments to select the region of electroluminescent material within each pixel which is active via the cathode array can be used to optimise the pixel lifetime and equalise the degradation rates of the different colour pixels within a display.

In a still further embodiment, the display panel is a liquid crystal display of a direct current switching type, such as a bistable flexoelectric mode display, in which a liquid crystal material forms a light modulating layer. The mode switching mechanism can in fact be utilised with any display type in which control of the pixel state requires control of the polarity of the voltage across the pixel. This includes electroluminescent displays as discussed, but also electrophoretic displays such as the E-Ink type and electrowetting displays.

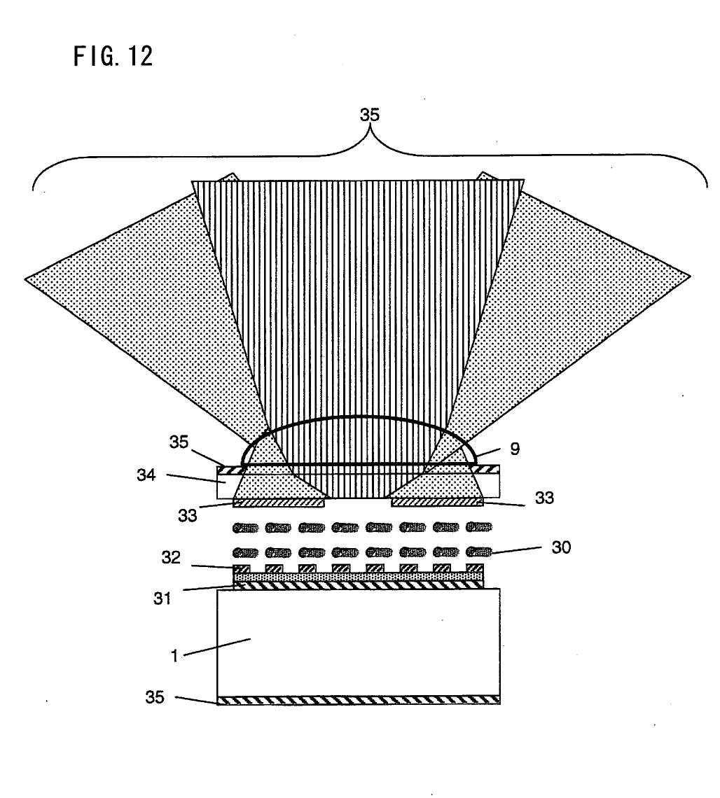

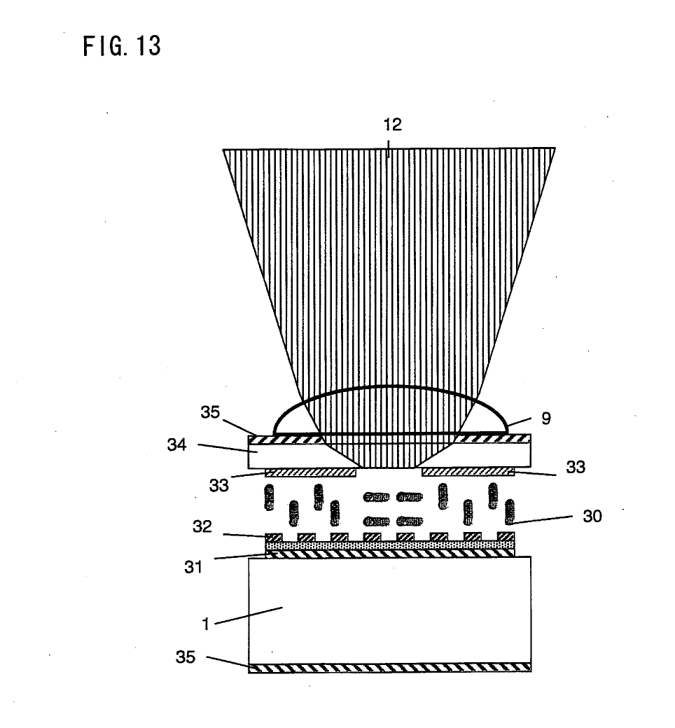

In a still further embodiment, illustrated in FIGS. 12 and 13, the display panel is a nematic liquid crystal display of the in-plane switching (IPS) or fringe-field switching (FFS, AFFS (advanced fringe-field switching, AFFS+; see http://www.boehydis.com/eng/main.htm) type. In this type of LCD, the usual limitation to switching off portions of each pixel by controlling the voltages on a plurality of counter electrodes, i.e. that there is no voltage which can be applied to the counter electrode that results in zero electric field through LC for all data voltages, can be circumvented.

This is due to the fact that, in these devices, a liquid crystal material, forming a light modulating layer, of positive dielectric anisotropy, 30, is aligned in a planar configuration, with the optic axis of the LC lying substantially parallel to the substrate surface in a direction parallel or perpendicular to the transmission axes of one of the crossed display polarisers 35,35′. A data voltage applied to the pixels in the active matrix array then produces an electric field between the pixel electrode, 31, and a common electrode, 32, also positioned on the active matrix substrate, 1, either interdigitated with the finger like pixel electrode in the case of IPS, or disposed on top of the pixel electrode with a separating insulating layer between in the case of FFS (SID Digest 2005, pp 1848-1851). This field causes a rotation of the LC director substantially in the plane of the cell resulting in transmission of light through the display polarisers,35,35′, to a wide range of viewing angles 36. This is standard in in-plane switching LCDs (U.S. Pat. No. 6,646,707).

In this embodiment, one or more additional electrodes,33, and a passive optical device, 9, are disposed on the counter substrate, 34, of the LC cell (This differentiates the embodiment from that disclosed in US20060267905A1 which uses a single uniform counter electrode and no additional passive optical arrangement). In the case of no voltage being applied to these electrodes, the display operates as a substantially unaltered IPS or FFS LCD with wide viewing angle characteristics, as shown in FIG. 12. A voltage can be applied to one or more of these counter electrodes which is large enough to reorient the LC out of the plane of the cell causing it to align substantially normal to the surfaces of the cell substrates. In this case the in-plane field resulting from the data voltage on each pixel will have no effect on the LC alignment and the regions of the display pixel subject to this field will appear dark between the crossed polarisers of the display for all data voltages. Therefore, although no zero-field condition can be achieved in the LC layer for all data voltages, portions of the pixel area can be made to always appear off.

A passive optical device, 9, can be positioned on the display counter substrate, 34, which causes the light transmitted by the pixel region not subject to the out-of-plane field, and which therefore still transmits light to a degree dependent on the pixel data voltage, to be directed into a restricted range of viewing angles 12, as illustrated in FIG. 13. In this way, a nematic LCD is provided in which the viewing angle characteristics are switchable globally across the whole display by control of the voltage on one or more counter electrodes opposing the active matrix substrate.

It should be noted that although the description above and accompanying figures outline a method to use this switching mechanism to provide a public to private switching mode LCD display, the combination of counter electrode geometry and passive optical arrangement can be varied to provide other multimode functions such as switchable dual-view, etc, as described in the other embodiments.

1. A display comprising a display device and a passive optical device, the display device comprising a light emitting or modulating layer disposed between first and second electrode arrangements, the first electrode arrangement comprising a plurality of pixel electrodes defining pixels of the display device, the second electrode arrangement comprising a plurality of counter electrodes arranged such that each of the pixel electrodes faces a portion of each of the counter electrodes, which are controllable so as to select which portion of each pixel is active to provide, in cooperation with the optical device, a plurality of display viewing modes having different angular viewing characteristics.

2. A display as claimed in claim 1, in which a first of the viewing modes is a private mode of restricted viewing angle.

3. A display as claimed in claim 1, in which a second of the viewing modes is a public mode of unrestricted viewing angle.

4. A display as claimed in claim 1, in which a third of the viewing modes is an autostereoscopic three dimensional mode.

5. A display as claimed in claim 1, in which a fourth of the viewing modes is a multiple view mode.

6. A display as claimed in claim 1, in which the optical device comprises a parallax optic.

7. A display as claimed in claim 6, in which the parallax optic comprises a one dimensional array of parallax elements.

8. A display as claimed in claim 6, in which the parallax optic comprises a two dimensional array of parallax elements.

9. A display as claimed in claim 6, in which the parallax optic comprises a lens array.

10. A display as claimed in claim 6, in which the parallax optic comprises a parallax barrier.

11. A display as claimed in claim 10, comprising a respective lens disposed in each aperture of the parallax barrier.

12. A display as claimed in claim 6, in which each pixel is aligned with a parallax element.

13. A display as claimed in claim 12, in which one of the portions of the counter electrodes facing each pixel electrode is substantially aligned with a centre of the pixel electrode.

14. A display as claimed in claim 13, in which the one portion is of smaller area than the other portions of the counter electrodes facing each pixel electrode.

15. A display as claimed in claim 12, in which first and second of the portions of the counter electrodes facing each pixel electrode are offset from a centre of the pixel electrode.

16. A display as claimed in claim 15, in which the first and second portions of the counter electrodes are arranged to be enabled alternately to provide time-sequential image display.

17. A display as claimed in claim 6, in which each parallax element is aligned with a respective portion of one of the counter electrodes, which portion partially overlaps a plurality of pixel electrodes.

18. A display as claimed in claim 1, in which the optical device comprises a patterned mirror.

19. A display as claimed in claimed in claim 18, in which the mirror has alternating first and second sections facing in substantially opposite directions.

20. A display as claimed in claim 19, in which the first sections comprise some of the portions of the counter electrodes and the second sections comprise portions of the pixel electrodes.

21. A display as claimed in claim 1, in which the light emitting or modulating layer is a light emitting diode layer.

22. A display as claimed in claim 21, in which the light emitting diode layer is an organic light emitting diode layer.

23. A display as claimed in claim 21, comprising gaps in the light emitting diode layer aligned with gap between the counter electrodes.

24. A display as claimed in claim 1, in which the light emitting or modulating layer is of controllable light transmissivity.

25. A display as claimed in claim 24, in which the light emitting or modulating layer comprises a liquid crystal layer.

26. A display as claimed in claim 25, in which the liquid crystal layer comprises a nematic liquid crystal layer of an in-plane switching or fringe-field switching type.

27. A display as claimed in claim 1, in which the display device is an active matrix display device.
